(19) United States
(12) Patent Application Publication
(10) Pub. No.: US 2026/0273595 A1
(43) Pub. Date: Sep. 17, 2026

(54) TANK CLEANING SYSTEM

(71) Applicant: Kadelco Pty Ltd, Sydney (AU)

(72) Inventors: Jesse CRAIG, Bennett Springs (AU); Kurt KING, Carramar (AU)

(21) Appl. No.: 19/470,855

(22) PCT Filed: Mar. 28, 2024
(86) PCT No.: PCT/AU2024/050291

§ 371 Date: Sep. 30, 2025

(30) Foreign Application Priority Data
Mar. 31, 2023 (AU) 2023900918

(51) Int. Cl. B08B 9/093; B08B 9/08; C02F 1/00; C02F 11/12; C02F 103/10

(52) U.S. Cl. CPC B08B 9/093; B08B 9/0856; C02F 11/12; C02F 2001/007; C02F 2103/10; C02F 2201/005; C02F 2303/14

(57) ABSTRACT

The present invention relates to, in a first aspect, a tank comprising one or more chambers separated from one another by a weir, an inlet that opens into a first thereof, and an outlet that opens into a last thereof, a drain associated with each of the chambers, the inlet and each of the drains having a valve, each being able to be separately actuated between an open and closed position, a plurality of spray nozzles arranged to spray fluid onto an inner surface of each of the chambers, a fluid pipe arranged to provide fluid to each spray nozzle, a flow control means, and a control module connected to the fluid pipe flow control means and each valve. Also provided are a bank of tanks, each comprising multiple chambers, as well as a kit for conversion of an existing tank.

### PRIORITY CLAIM

The present application claims priority from AU 2023900918, filed in Australia on 31 Mar. 2023. The contents of the priority application are hereby incorporated herein by reference.

### TECHNICAL FIELD

The present invention relates generally to the field of storage, holding and other tanks, and more particularly to the field of cleaning tanks.

### BACKGROUND

Underground mines generate large amounts of dust, dirt and other waste particulate, which are often collected with water for extraction and cleaning purposes. The resulting shale particles and mud may be purified or pumped elsewhere, but must first have the suspended particulate stripped out of suspension to ensure that downstream machinery does not get damaged or clogged.

To achieve this, the dirty water and mud is typically collected in large, chambered separation tanks (also known as hoppers). These are large tanks that are divided into chambers by internal weirs. The mud is passed into the first chamber and allowed residence time (allowed to settle); partially clear water passes over the weir, while entrained particulate sinks to the bottom. The process is then repeated in each chamber in sequence, with mud and other entrained particulate matter being allowed to settle out of suspension each time while the liquid passes over the weir into the next chamber. Eventually, water that has been cleaned to a practical extent exits the tank through an outlet and may in some instances be recycled for reuse in production collecting further mud.

The mud tanks must be periodically cleaned. In prior systems, this involves opening drainage valves at the base of each chamber and manually breaking up, removing and hosing out the collected mud and particulate matter. However, this can be risky with manned entry in some instances and requires that the cleaning crew are trained to operate in confined spaces. The process also requires constant supervision due to the inherent risks, and so the process becomes arduous, time-consuming and a drain on manpower for the mine. Finally, the process typically requires machinery such as drills, rotary hammers, and so on to break up the deposits, which can become cemented against the tank walls, which poses its own set of problems around providing equipment and power into the tank as well as manoeuvring the equipment around within the confined space

The present invention seeks to alleviate the risks and downsides of the prior art.

### DISCLOSURE OF THE INVENTION

In a first aspect, the present invention comprises a self-cleaning tank, comprising one or more chambers arranged in sequence and separated from one another by a weir or overflow, an inlet that opens into a first of the one or more sequential chambers, and an outlet that opens into a last of the one or more sequential chambers, the one or more chambers being unpressurised, at least one drain associated with each of the one or more chambers, the inlet having an inlet valve, and each of the at least one drains having a drain valve, the inlet valve and each of the drain valves being able to be separately actuated between an open position and a closed position, a plurality of spray nozzles arranged to spray fluid onto an inner surface of each of the one or more chambers, a fluid pipe arranged to provide fluid to each of the plurality of spray nozzles, a fluid pipe flow control means associated with the fluid pipe adapted to control a flow of fluid through the pipe, and a control module connected to the fluid pipe flow control means, the inlet valve and each of the drain valves. In an embodiment, the plurality of spray nozzles are arranged at, proximal to or above an upper end of each of the one or more chambers, and each of the plurality of spray nozzles are configured to spray the fluid onto at least one inner surface of at least one of the one or more chambers.

In an embodiment, the plurality of spray nozzles are arranged into one or more nozzle arrays, each of the one or more sequential chambers having at least one of the one or more nozzle arrays associated therewith. In an embodiment, each nozzle array further comprises an array valve associated therewith which is able to be actuated between an open position and a closed position, and the control module is connected to the array valve.

In an embodiment, the control module is configured to execute a tank cleaning process, comprising, in any suitable order, the operations of: actuating the inlet valve into the closed position, actuating the drain valves of the one or more chambers into the open position, transmitting a signal to the fluid pipe flow control means to provide fluid through the fluid pipe, in turn, transmitting a signal to the fluid pipe flow control means to stop provision of fluid, actuating the drain valves into the closed position, and actuating the inlet valve into the open position.

In an embodiment, the control module is configured to execute a tank cleaning process comprising, in any suitable order, the operations of: actuating the inlet valve into the closed position, transmitting a signal to the fluid pipe flow control means to provide fluid through the fluid pipe, for each particular chamber of the one or more chambers: actuating the drain valve associated with the drains of the particular chamber into the open position, actuating the array valve of the nozzle array associated with the particular chamber into the open position in due course, actuating the array valve into the closed position, and actuating the drain valve into the closed position; in due course, transmitting a signal to the fluid pipe flow control means to stop provision of fluid, and actuating the inlet valve into the open position. In an embodiment, the control module executes the operations for each particular chamber in turn. In an embodiment, the fluid is pressurised to at least 550 kPa.

A further aspect of the invention may lie in a mud holding and separation bank, comprising two or more self-cleaning tanks of an embodiment of the first aspect.

In an embodiment, the mud holding and separation bank may comprise a common fluid pipe arranged to provide fluid to the nozzle arrays of one or more of the two or more self-cleaning tanks. In an embodiment, the mud holding and separation bank may comprise a common control module connected to the fluid pipe flow control means, the actuatable inlet valve and each of the actuatable drain valves of one or more of the two or more self-cleaning tanks.

In an embodiment, the two or more self-cleaning tanks are arranged in parallel to one another. In an embodiment, the two or more self-cleaning tanks are arranged in series. In an embodiment, there are three or more self-cleaning tanks, one or more of the three or more self-cleaning tanks are arranged in parallel to one another, and one or more of the three or more self-cleaning tanks are arranged in series.

Further or alternative embodiments of the invention may be disclosed herein or may otherwise become apparent to the person skilled in the art through the disclosure herein. These and other embodiments are considered to fall within the scope and object of the invention.

### DESCRIPTION OF FIGURES

Embodiments of the present invention will now be described in relation to figures, wherein:

FIG. 1 depicts an embodiment of a self-cleaning tank of the present invention;

FIG. 2 depicts a four-chambered embodiment of the present invention;

FIG. 3 depicts an embodiment of a nozzle sub-array;

FIG. 4 depicts a Process Flow Diagram of an embodiment of a self-cleaning tank of the present invention;

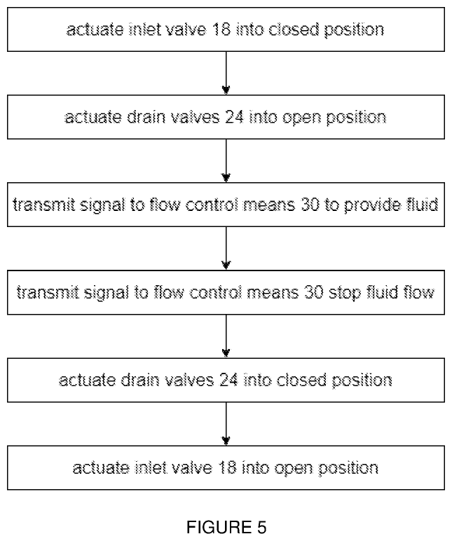

FIGS. 5-7 depict different embodiments of a cleaning process executed by an embodiment of the present invention;

FIG. 8 depicts an embodiment of a mud holding and separation bank;

FIG. 9 depicts further alternative embodiments of a mud holding and separation bank; and

FIG. 10 depicts an embodiment of a kit of the present invention.

### DETAILED DESCRIPTION OF PREFERRED EMBODIMENTS

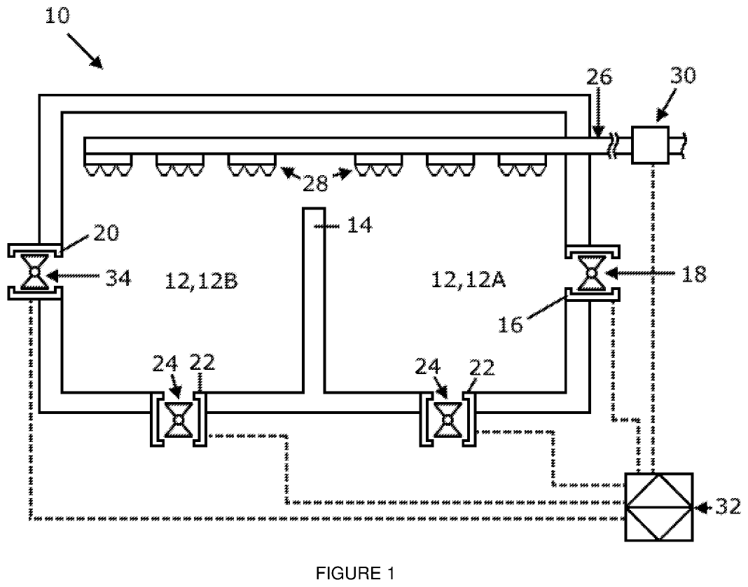

In a first aspect and with reference to FIG. 1, the present invention may comprise a self-cleaning tank 10, comprising at least two chambers 12 arranged in sequence and separated from one another by a weir 14, an inlet 16 that opens into a first 12A of the at least two sequential chambers and having an inlet valve 18, an outlet 20 that opens into a last 12B of the at least two sequential chambers, at least one drain 22 for each chamber 12 having a drain valve 24 installed therewithin, a fluid pipe 26, a plurality of spray nozzles 28, a flow control means 30, and a control module 32. In an embodiment, the outlet 20 may have an outlet valve 34.

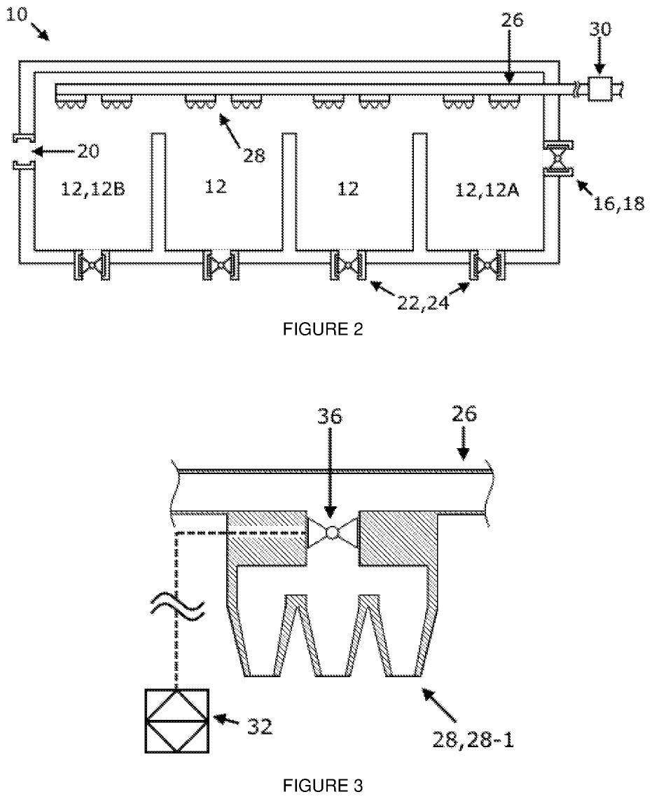

The person skilled in the art will appreciate that while FIG. 1 depicts a tank 10 comprising only a pair of chambers, this is exemplary only and the tank may comprise any number of chambers 12 arranged in sequence. For example, FIG. 2 depicts a tank comprising four chambers 12. For clarity, FIG. 2 does not depict the control module 32 or its connections.

In an embodiment, the tank 10 may be a tank that is designed to hold or contain mud, and may be adapted to enable the mud to at least partially settle and/or separate into at least partially clarified liquid and the suspended solid material. As used herein, the term ‘mud’ refers to solid particulate mixed with liquid, and includes liquid with entrained or suspended particulate matter as well as deposits formed thereby. Some non-limiting examples of mud are clay, silt, loam or other earth and/or stone particulate mixed with water; organic matter and earth suspended in or carried by liquids, such as dirty or muddy water; ‘drilling mud’; particulate-carrying runoff or wastewater from industrial processes such as mining and minerals processing; and any other liquid, suspension or deposit that would be referred to as ‘mud’ by the person skilled in the art.

In an embodiment, the inlet valve 18 and each of the drain valves 24 (and outlet valve 34, if present) may be between an open position and a closed position. In an open position, material may pass through the inlet 16 or drain 22, respectively, while in a closed position, material is unable to pass therethrough. With reference to FIG. 1, the inlet valve 18 and outlet valve 34 are depicted in the closed position, while the drain valves 24 are depicted in the open position.

In an embodiment, the plurality of spray nozzles 28 may be arranged to receive fluid provided by or through the fluid pipe 26, and may comprise a plurality of nozzles that are arranged to spray the received fluid into the at least two chambers 12. In a particular embodiment, various ones of the plurality of nozzles may be arranged to direct the fluid towards walls or inner surfaces 12-1 of each chamber 12. The fluid may be water or may be a cleaning fluid. The inner surface 12-1 may be a surface of the weir 14. The water may be ‘dirty’ or mine water.

In an embodiment, the tank 10 is an unpressurised vessel. In a further embodiment, the one or more chambers 12 are open-topped, and at least the plurality of spray nozzles 28 may be arranged at, proximal to or above an upper end 12-2 of each of the one or more chambers 12. In an embodiment, the plurality of spray nozzles 28 are configured to spray the fluid onto the respective inner surface 12-1 of the one or more chambers 12. In a further embodiment, the spray nozzles 28 are arranged and adapted to spray the fluid to optimally dislodge, break up and otherwise remove solids that have settled or adhered to the chamber walls or inner surfaces 12-1.

In an embodiment, the fluid is pressurised to at least 550 kPa. In a further embodiment, a number of spray nozzles 28 that are utilised simultaneously may be directly proportional to a pressure of the provided fluid. It is considered that high pressure is necessary to reduce the time to dislodge, break up and otherwise remove solids that have settled or adhered to the chamber walls. As such, in embodiments wherein the fluid is provided at a lowered pressure, the self-cleaning tank 10 may need to conduct multiple cleaning cycles and/or clean the individual chambers 12 in stages to ensure that the chambers 12 are fully cleaned.

In an embodiment, the control module 32 is connected to the flow control means 30, the inlet valve 18 (and outlet valve 34, if present) and each of the drain valves 24. The control module may be configured to run at least one cleaning program, operation or subroutine and may be able to control and/or actuate the fluid pipe flow control means 30, the inlet valve 18 (and outlet valve 34, if present) and each of the drain valves 24. In a further embodiment, the control module 32 may be configured to be automated.

In an embodiment, the flow control means 30 may be a pump that pumps fluid into the fluid pipe 26. In an alternate embodiment, the flow control means 30 may be a valve having an open and a closed position. The person skilled in the art will appreciate that there may be other forms of fluid flow control known in the art, and the use thereof does not depart from the scope or object of the invention.

In an embodiment, the control module 32 may be further connected to the plurality of spray nozzles 28. In a further embodiment, one or more nozzles of the nozzle array may be adjustable in at least one parameter thereof, such as spray direction, spray pattern, spray strength, etc. The control module 32 may be configured to control adjustment of the one or more nozzles. In a further embodiment, the control module may be adapted to receive manual input to control adjustment of the one or more nozzles.

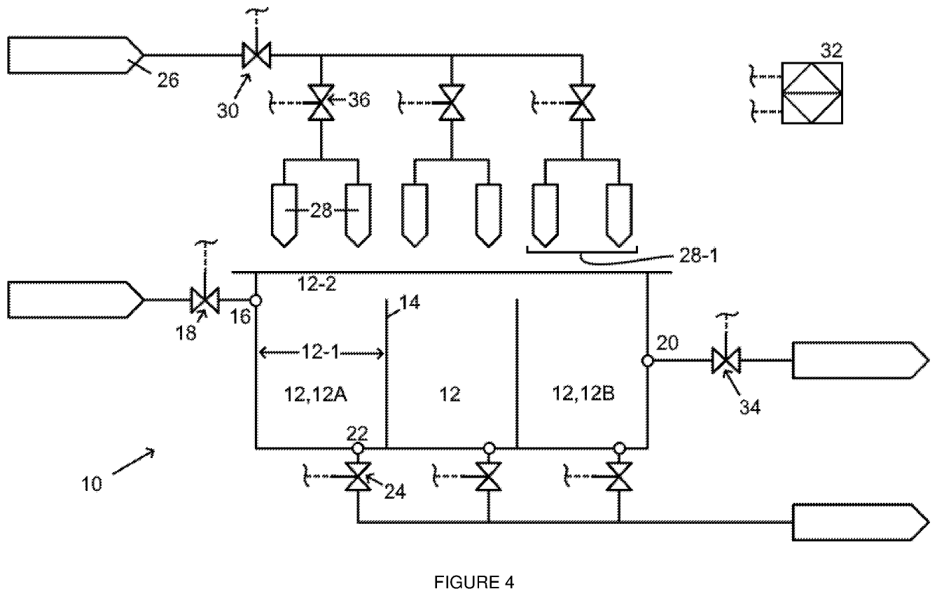

In an embodiment and with reference to FIG. 6, the plurality of spray nozzles 28 may be arranged into one or more nozzle arrays 28-1, wherein each of the one or more sequential chambers 12 have at least one of the one or more nozzle arrays 28-1 associated therewith. The nozzle array 28-1 may be adapted to spray fluid into a particular one of the at least two chambers 12. In a further embodiment, the tank 10 may comprise separate nozzle arrays 28-1 for each chamber 12. In an alternate (but non-exclusive) embodiment, there may be a plurality of nozzle arrays arranged to spray fluid onto various portions of the same chamber 12. In a further embodiment and with reference to FIG. 3, the nozzle arrays may further comprise an array valve 36 that is able to be actuated between an open position and a closed position. In a further embodiment, the control module 32 may be connected to the array valve 36. The control module 32 may be adapted to actuate separate ones of the plurality of array valves 36 separately and independently of one another. In FIG. 6, the control wires are only partially depicted in order to maintain clarity, however the person skilled in the art will appreciate that control wires extend between the control module 32 and each component that is controlled thereby.

In an embodiment, the control module 32 may be configured with multiple clean and drain programs to address different situations. For example, in an embodiment wherein mud and other solids are heavily deposited, the control module may activate a single nozzle array 28-1 at a time in order to maximise pressure—and thus cleaning ability—of the sprayed cleaning fluid.

In addition if the mine process conditions changed and the tank became full the system has a high level alarm which will trigger automated additional cleans, due to the specific height and positioning of the nozzle array the system will still compete an effective although longer clean cycle

In an embodiment, the self-cleaning tank 10 may comprise a plurality of fluid pipes 26, each in fluid communication with either the at least one plurality of spray nozzles 28, or at least one of the nozzle arrays 28-1, or both, depending upon which embodiment of the at least one plurality of spray nozzles 28 is present. Each of the plurality of fluid pipes 26 may comprise separate flow control means 30, and each separate flow control means may be independently operated by the control module 32.

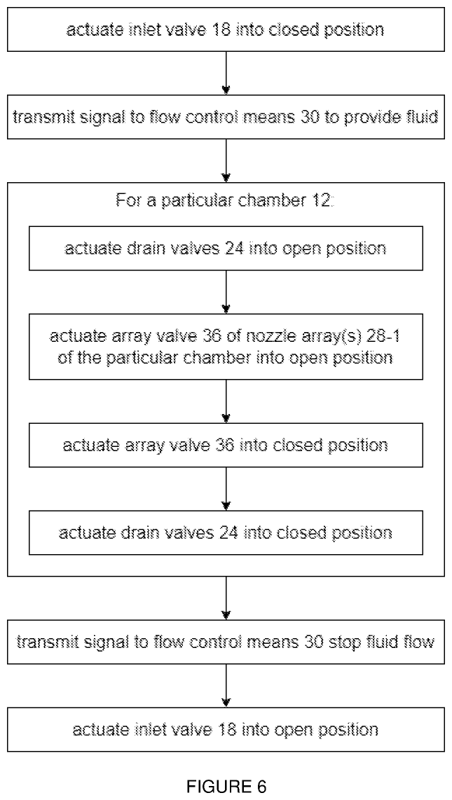

In an embodiment and with reference to FIG. 5, the control module 32 is configured to execute a tank cleaning process. The tank cleaning process may comprise, in any suitable order, the operations of:
(a) actuating the inlet valve 18 into the closed position;
(b) actuating the drain valves 24 into the open position;
(c) transmitting a signal to the flow control means 30 to provide fluid through the fluid pipe 26;
(d) in turn, transmitting a signal to the flow control means 30 to stop provision of fluid through the fluid pipe 26;
(e) actuating the drain valves 24 into the closed position; and
(f) actuating the inlet valve 18 into the open position.

In an embodiment wherein the self-cleaning tank 10 comprises an outlet valve 34 within the outlet 20, the tank cleaning program operation (a) may additionally comprise actuating the outlet valve 34 into the closed position, and operation (f) may further comprise actuating the outlet valve 34 into the open position.

In an embodiment wherein the self-cleaning tank 10 comprises nozzle arrays 28-1 associated with separate chambers 12, and with reference to FIG. 6, the control module 32 may be adapted to execute a tank cleaning process for one or some particular chambers 12 at a time. The tank cleaning process may comprise, in any suitable order, the operations of:
(a) actuating the inlet valve 18 (and outlet valve 34, if present) into the closed position;
(b) transmitting a signal to the flow control means 30 to provide fluid through the fluid pipe 26;
(c) for each particular chamber:
   (i) actuating the drain valve 24 of the particular chamber 12 into the open position;
   (ii) actuating the array valve 36 of the nozzle array(s) 28-1 that is/are arranged to spray fluid into the particular chamber into the open position;
   (iii) in due course, actuating the array valve 36 into the closed position; and
   (iv) actuating the drain valve 24 into the closed position;
(d) in due course, transmitting a signal to the flow control means 30 to stop provision of fluid; and
(e) actuating the inlet valve 18 (and outlet valve 34, if present) into the open position.

In an alternative embodiment and with reference to FIG. 7, all of the drain valves 24 may be actuated into the open position prior to step (c) (i.e. step (c) begins with sub-step (ii)), and/or all of the drain valves 24 may be actuated into the closed position after step (c) (i.e. step (c) concludes with sub-step (iii)).

In one further embodiment, operations (c)(i)-(c)(iv) are conducted for one chamber 12 at a time, or simultaneously for only some chambers 12, i.e. not all of the array valves 36 are opened at the same time. By way of non-limiting example, in a self-cleaning tank 10 comprising four chambers 12, each having their own nozzle array, the nozzle arrays for the first and second chamber may be activated (valves opened) at the same time, and deactivated (valves closed) before the nozzle arrays for the third and fourth chambers are activated. Alternatively, only the nozzle arrays 28-1 associated with a particular one of the four chambers 12 may be opened at a time. Such arrangements may be beneficial to embodiments wherein, for example a pressure or flow rate of the fluid provided by the flow control means 30 to the fluid pipe(s) 26 is insufficient to properly clean all of the chambers 12 within the self-cleaning tank 10 at the same time. In one further embodiment, operations (c)(i)-(c)(iv) are conducted separately for each chamber 12 in the two or more chambers 12.

In one further embodiment, instead of operation (c)(i) being conducted for each tank in sequence, the tank cleaning process may comprise an operation, prior to operation (c), wherein some or all of the nozzle array valves 36 are opened. In one further embodiment, instead of operation (c)(iv) being conducted for each tank in sequence, the tank cleaning process may comprise an operation, after completion of operation (c), wherein some or all of the nozzle array valves 36 are closed.

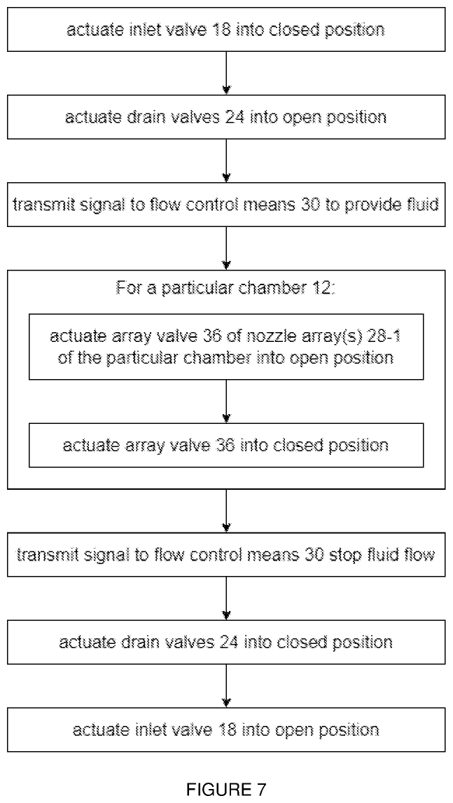

A second aspect of the invention, and with reference to FIG. 8, may lie in a mud holding and separation bank 100, comprising two or more self-cleaning tanks 10-1, 10-2 of any one of the above embodiments. FIG. 8 omits certain elements and abstracts others to maintain clarity, but the skilled person will appreciate that these elements are still present. For example, control module 32 is depicted as being connected to each self-cleaning tank 10-1, 10-2, but the skilled person will understand that these are connections to the valves of the inlets 16, drains 22 and outlets 20 (if present). Similarly, fluid pipe 26 is depicted simply as entering each self-cleaning tank 10-1, 10-2, but the skilled person will appreciate that in each case there are one or more nozzle arrays 28 and/or arrays 28-1 being supplied.

In an embodiment, the mud holding and separation bank 100 may comprise a common fluid pipe 26 that is arranged to provide fluid to the nozzle arrays 28 of at least two of the two or more self-cleaning tanks 10-1, 10-2. In an alternate embodiment, at least one of the two or more self-cleaning tanks 10-1, 10-2 may have their own fluid pipe 26. This may be beneficial in embodiments wherein, for example, one of the self-cleaning tanks requires more frequent cleaning or cleaning at a higher pressure than the other tanks in the mud holding and separation bank 100.

In an embodiment, the mud holding and separation bank 100 may comprise a common control module 32 connected to the flow control means 30, the inlet valve 18, (and the outlet valve 34, if present) and each of the drain valves 24 of at least two of the two or more self-cleaning tanks 10-1, 10-2.

In an embodiment, two or more self-cleaning tanks 10-1, 10-2 within the mud holding and separation bank 100 may be arranged in parallel to one another. In such an embodiment, these two or more self-cleaning tanks 10-1, 10-2 receive input, through their respective inlets 16, from the same source. In an alternate but non-exclusive embodiment, two or more self-cleaning tanks 10-1, 10-2 within the mud holding and separation bank 100 may be arranged in series, such that the outlet 20 from one of the self-cleaning tanks is connected to the inlet 16 of the next.

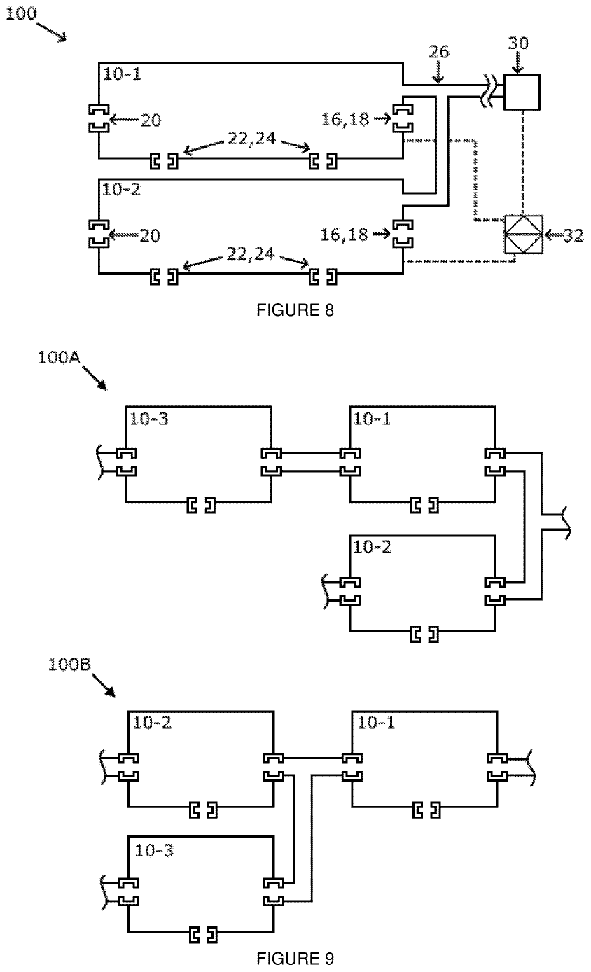

In a further embodiment of both non-exclusively alternate embodiments discussed immediately prior, the mud holding and separation bank 100 may comprise three or more self-cleaning tanks 10-1, 10-2, 10-3, wherein some of the self-cleaning tanks are arranged in series with one another and some of the self-cleaning tanks are arranged in parallel. FIG. 9 depicts two possible arrangements of the aforementioned embodiment, being a first mud holding and separation bank 100A and a second mud holding and separation bank 100B. In further embodiments, a particular self-cleaning tank within the mud holding and separation bank may be in parallel with one or more self-cleaning tanks and may be in series with one or more other self-cleaning tanks within the mud holding and separation bank.

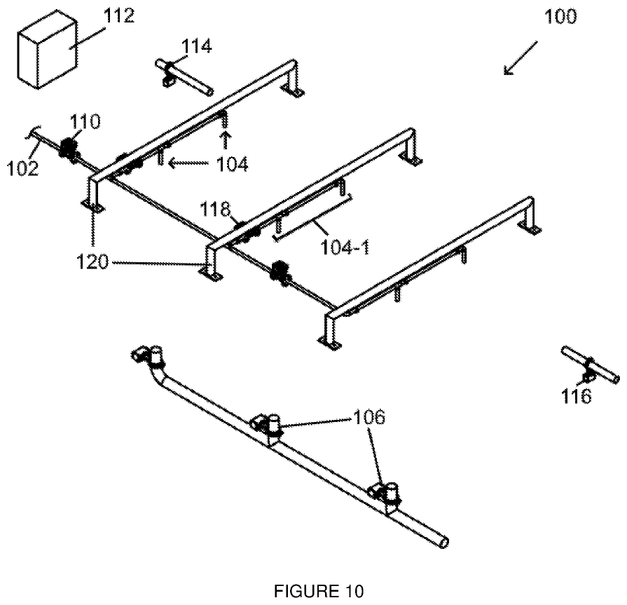

A further aspect of the invention may lie in a self-cleaning conversion kit for retrofitting to a prior art mud holding tank comprising one or more internal chambers into an embodiment of the first aspect of the invention. In an embodiment and with reference to FIG. 10, the kit 100 may comprise a fluid pipe 102, a plurality of spray nozzles 104, a drain valve 106 for each drain within the tank, a flow control means 110, and a control module 112. In an embodiment, the kit may further comprise an inlet valve 114 and/or an outlet valve 116. In further embodiments, the kit may comprise one or more nozzle arrays 104-1 comprising an array valve 118. The control module 112 may be connectable thereto and able to actuate the valve 118. In a further embodiment, the kit 100 may comprise one or more scaffolds 120 mountable to an upper end of the tank for mounting the plurality of nozzles 104 and/or nozzle arrays 104-1 thereto.

While the invention has been described with reference to preferred embodiments above, it will be appreciated by those skilled in the art that it is not limited to those embodiments, but may be embodied in many other forms, variations and modifications other than those specifically described. The invention includes all such variation and modifications. The invention also includes all of the steps, features, components and/or devices referred to or indicated in the specification, individually or collectively and any and all combinations or any two or more of the steps or features.

In this specification, unless the context clearly indicates otherwise, the word “comprising” is not intended to have the exclusive meaning of the word such as “consisting only of”, but rather has the non-exclusive meaning, in the sense of “including at least”. The same applies, with corresponding grammatical changes, to other forms of the word such as “comprise”, etc.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

Any promises made in the present document should be understood to relate to some embodiments of the invention, and are not intended to be promises made about the invention in all embodiments. Where there are promises that are deemed to apply to all embodiments of the invention, the applicant/patentee reserves the right to later delete them from the description and they do not rely on these promises for the acceptance or subsequent grant of a patent in any country.

1. A self-cleaning tank, comprising:
two or more chambers arranged in sequence and separated from one another by a weir or overflow, an inlet that opens into a first of the two or more sequential chambers, and an outlet that opens into a last of the two or more sequential chambers, each of the two or more chambers being unpressurised;
at least one drain associated with each of the two or more chambers;
the inlet having an inlet valve, and each of the at least one drains having a drain valve, the inlet valve and each of the drain valves being able to be separately actuated between an open position and a closed position;
a plurality of spray nozzles arranged to spray fluid onto an inner surface of each of the two or more chambers;
a fluid pipe arranged to provide fluid to each of the plurality of spray nozzles;
a fluid pipe flow control means associated with the fluid pipe adapted to control a flow of fluid through the pipe; and
a control module connected to the fluid pipe flow control means, the inlet valve and each of the drain valves.

2. The self-cleaning tank of claim 1, wherein the plurality of spray nozzles are arranged at, proximal to or above an upper end of each of the two or more chambers; and
each of the plurality of spray nozzles are configured to spray the fluid onto at least one inner surface of at least one of the two or more chambers.

3. The self-cleaning tank of claim 1, wherein the plurality of spray nozzles are arranged into one or more nozzle arrays, each of the two or more sequential chambers having at least one of the one or more nozzle arrays associated therewith.

4. The self-cleaning tank of claim 3, wherein each nozzle array further comprises an array valve associated therewith which is able to be actuated between an open position and a closed position; and
the control module is connected to the array valve.

5. The self-cleaning tank of claim 1, wherein the control module is configured to execute a tank cleaning process, comprising the operations of:
actuating the inlet valve into the closed position;
actuating the drain valves of the two or more chambers into the open position;
transmitting a signal to the fluid pipe flow control means to provide fluid through the fluid pipe;
in turn, transmitting a signal to the fluid pipe flow control means to stop provision of fluid;
actuating the drain valves into the closed position; and
actuating the inlet valve into the open position.

6. The self-cleaning tank of claim 4, wherein the control module is configured to execute a tank cleaning process, comprising the operations of:
actuating the inlet valve into the closed position;
transmitting a signal to the fluid pipe flow control means to provide fluid through the fluid pipe;
for each particular chamber of the two or more chambers:
actuating the drain valve associated with the drains of the particular chamber into the open position;
actuating the array valve of the nozzle array associated with the particular chamber into the open position;
in due course, actuating the array valve into the closed position; and
actuating the drain valve into the closed position;
in due course, transmitting a signal to the fluid pipe flow control means to stop provision of fluid; and
actuating the inlet valve into the open position.

7. The self-cleaning tank of claim 6, wherein the control module executes the operations for each particular chamber in turn.

8. The self-cleaning tank of claim 1, wherein the fluid is pressurised to at least 550 kPa.

9. A mud holding and separation bank, comprising three or more self-cleaning tanks of claim 1.

10. The mud holding and separation bank of claim 9, comprising a common fluid pipe arranged to provide fluid to the nozzle arrays of two or more of the three or more self-cleaning tanks.

11. The mud holding and separation bank of claim 9, comprising a common control module connected to the fluid pipe flow control means, the actuatable inlet valve and each of the actuatable drain valves of one or more of the two or more self-cleaning tanks.

12. The mud holding and separation bank of claim 9, wherein the three or more self-cleaning tanks are arranged in parallel to one another.

13. The mud holding and separation bank of claim 9, wherein the three or more self-cleaning tanks are arranged in series.

14. The mud holding and separation bank of claim 9, wherein there are four or more self-cleaning tanks;
two or more of the four or more self-cleaning tanks are arranged in parallel to one another; and
two or more of the four or more self-cleaning tanks are arranged in series.

15. The mud holding and separation bank of claim 1 wherein the fluid that is sprayed onto an inner surface of each of the two or more chambers is water.

16. The mud holding and separation bank of claim 15 wherein the water is ‘dirty’ or mine water.
